(19) United States
(12) Patent Application Publication
(10) Pub. No.: US 2024/0213625 A1
(43) Pub. Date: Jun. 27, 2024

(54) CELL LAMINATE

(71) Applicant: HONDA MOTOR CO., LTD., Tokyo (JP)

(72) Inventors: Hideki SAKAMOTO, Saitama (JP); Harumi TAKEDOMI, Saitama (JP); Soichi MORII, Saitama (JP)

(73) Assignee: HONDA MOTOR CO., LTD., Tokyo (JP)

(21) Appl. No.: 18/545,460

(22) Filed: Dec. 19, 2023

(30) Foreign Application Priority Data
Dec. 21, 2022 (JP) 2022-204421

(51) Int. Cl. H01M 50/503; H01M 50/178; H01M 50/186; H01M 50/211; H01M 50/522

(52) U.S. Cl. CPC H01M 50/503; H01M 50/178; H01M 50/186; H01M 50/211; H01M 50/522

(57) ABSTRACT

A cell laminate includes: a plurality of laminated cells which are laminated, wherein each laminated cell includes a sealing portion on a peripheral edge, and is configured such that a tab lead extends from the sealing portion in a direction perpendicular to a lamination direction, the tab leads of at least four laminated cells among the plurality of laminated cells are electrically connected to each other via a conductive connection member having a plate shape, each tab lead connected to the conductive connection member has a linear portion extending linearly in the direction perpendicular to the lamination direction from the sealing portion to a tip end, and the tip ends are bonded in close contact with the conductive connection member by a surface, which is parallel to an extension direction of the tab leads, of surfaces of the conductive connection member.

### CROSS-REFERENCE TO RELATED APPLICATIONS

This application is based on and claims priority under 35 USC 119 from Japanese Patent Application No. 2022-204421 filed on Dec. 21, 2022, the entire content of which is incorporated herein by reference.

### TECHNICAL FIELD

The present invention relates to a cell laminate including a plurality of laminated cells which are laminated.

### BACKGROUND ART

In recent years, researches and developments have been conducted on a secondary battery which contributes to improvement in energy efficiency in order to allow more people to have access to affordable, reliable, sustainable, and advanced energy.

A laminated cell is known as a secondary battery (for example, JP2011-249243A). JP2011-249243A describes a structure in which cell electrodes of a plurality of laminated cells are welded to a busbar, and the cell electrodes are electrically connected to each other.

### SUMMARY OF INVENTION

In JP2011-249243A, the cell electrodes of two adjacent laminated cells are connected in series via the busbar, but in some cases, the plurality of laminated cells may be connected in parallel and in series. In this case, as in JP2011-249243A, it is common to connect the cell electrodes via the busbar.

FIG. 13 shows an example of a structure in which positive electrode tab leads 201 of two laminated cells 200A connected in parallel and negative electrode tab leads 202 of two laminated cells 200B connected in parallel are connected in series via a conductive connection member 300. Four laminated cells are laminated in a left-right direction in the drawing. FIG. 14 is a cross-sectional view taken along a line Z-Z in FIG. 13.

The positive electrode tab lead 201 of the laminated cell 200A and the negative electrode tab lead 202 of the laminated cell 200B on an outer side in a lamination direction are bent 90 degrees from both ends of the conductive connection member 300 in the lamination direction, and are bonded on a surface of the conductive connection member 300. Two slits 301 arranged side by side in the lamination direction are provided in a central portion of the conductive connection member 300, the positive electrode tab lead 201 of the laminated cell 200A and the negative electrode tab lead 202 of the laminated cell 200B on an inner side in the lamination direction are inserted through the slits 301, respectively. The positive electrode tab lead 201 and the negative electrode tab lead 202 inserted through the slits 301 are bent by 90 degrees, and are bonded on the surface of the conductive connection member 300 between the two slits 301.

Since the slits 301 are provided in a region between both ends 302 in an upper-lower direction of the conductive connection member 300, the conductive connection member 300 is not electrically connected to any of the positive electrode tab leads 201 and the negative electrode tab leads 202 in the lamination direction of the laminated cells 200A and 200B (see FIG. 14).

Therefore, both ends 302 of the conductive connection member 300 function as conductive portions to electrically connect the positive electrode tab leads and the negative electrode tab leads. In a configuration shown in FIG. 13, spaces are required above and below the positive electrode tab leads 201 and the negative electrode tab leads 202 in order to provide both ends 302. In order to secure conductive areas of both ends 302, the entire conductive connection member 300 tends to be thick.

Aspect of non-limiting embodiments of the present disclosure relates to provide a cell laminate capable of connecting tab leads of a plurality of laminated cells and a conductive connection member in a space-saving manner.

According to the present invention, it is possible to connect tab leads of a plurality of laminated cells and a conductive connection member in a space-saving manner.

### BRIEF DESCRIPTION OF DRAWINGS

FIG. 1 is a schematic plan view of a cell laminate 1 according to each embodiment of the present invention, and schematically shows an electrical flow path of the cell laminate 1;

FIG. 2 is a perspective view of a laminated cell 2:

FIG. 3 is a diagram showing connection of tab leads 21 and 22 of six adjacent laminated cells 2A and 2B in the cell laminate 1 according to a first embodiment;

FIG. 4 is a front view of a conductive connection member 30;

FIG. 5 is a diagram showing that the conductive connection member 30 and the tab leads 21 and 22 are conducted in a lamination direction without interruption;

FIG. 6 is a diagram illustrating a method for manufacturing the cell laminate 1 according to the first embodiment:

FIG. 7 is a diagram showing a chamfered portion 34 of the conductive connection member 30 according to a first modification;

FIG. 8 is a front view of the conductive connection member 30 according to a second modification;

FIG. 9 is a diagram showing connection of the tab leads 21 and 22 of the four adjacent laminated cells 2A and 2B in the cell laminate 1 according to a second embodiment;

FIG. 10 is a diagram illustrating connection between the tab leads 21 and 22 of the four adjacent laminated cells 2A and 2B and a conductive connection member 40 in the second embodiment;

FIG. 11 is a diagram illustrating connection between the tab leads 21 and 22 of the eight adjacent laminated cells 2A and 2B and the conductive connection member 40 in the second embodiment;

FIG. 12 is a diagram illustrating connection between the tab leads 21 and 22 of the six adjacent laminated cells 2A and 2B and the conductive connection member 40 in the second embodiment;

FIG. 13 is a diagram showing a structure in the related art in which two laminated cells 200A connected in parallel and two laminated cells 200B connected in parallel are connected in series via a conductive connection member 300; and

FIG. 14 is a cross-sectional view taken along a line Z-Z in FIG. 13.

### DESCRIPTION OF EMBODIMENTS

Hereinafter, a cell laminate according to each embodiment of the present invention will be described with reference to the accompanying drawings.

### First Embodiment

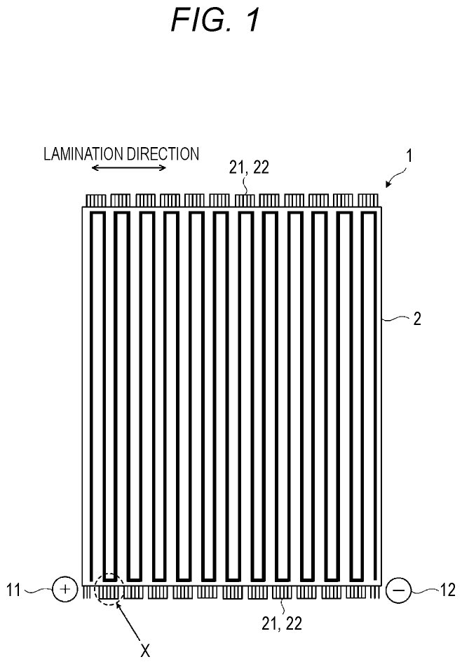

A cell laminate 1 according to a first embodiment of the present invention will be described. FIG. 1 is a schematic plan view of the cell laminate 1. The cell laminate 1 includes a plurality of laminated cells 2 which are laminated in a horizontal direction (a left-right direction in FIG. 1). Although not shown, the cell laminate 1 is housed in a battery case and placed, for example, under a floor (below a floor panel) of a vehicle.

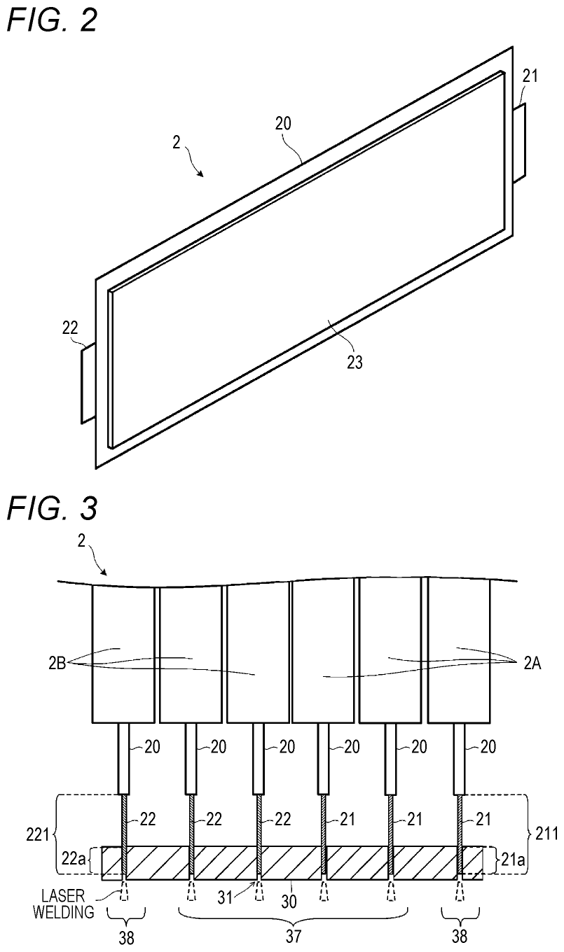

FIG. 2 is a perspective view of the laminated cell 2. The laminated cell 2 is, for example, a solid-state battery. The laminated cell 2 implemented by the solid-state battery includes a positive electrode to which a positive electrode tab lead 21 is connected, a negative electrode to which a negative electrode tab lead 22 is connected, a solid electrolyte disposed between the positive electrode and the negative electrode, and a laminated film 23 that houses the positive electrode, the negative electrode, and the solid electrolyte, and performs charging and discharging by transferring lithium ions between the positive electrode and the negative electrode via the solid electrolyte. A sealing portion 20 is provided on a peripheral edge of the laminated cell 2. When the positive electrode tab lead 21 and the negative electrode tab lead 22 are not distinguished from each other, the positive electrode tab lead 21 and the negative electrode tab lead 22 are also simply referred to as tab leads 21 and 22.

The positive electrode tab lead 21 extends from the sealing portion 20 at one end in a longitudinal direction of the laminated cell 2, and the negative electrode tab lead 22 extends from the sealing portion 20 at the other end in the longitudinal direction of the laminated cell 2. The positive electrode including the positive electrode tab lead 21 is made of aluminum, for example. The negative electrode including the negative electrode tab lead 22 is made of copper, for example.

The solid electrolyte of the solid-state battery is not particularly limited as long as the solid electrolyte has lithium ion conductivity and insulation, and materials generally used for an all-solid-state lithium ion battery can be used. Examples can include sulfide solid electrolyte materials, oxide solid electrolyte materials, inorganic solid electrolytes such as lithium-containing salts, polymer-based solid electrolytes such as polyethylene oxide, and gel-based solid electrolytes containing lithium-containing salts and lithium-ion conductive ionic liquids. A form of the solid electrolyte material is not particularly limited, but may be, for example, a particulate form.

Returning to FIG. 1, the plurality of laminated cells 2 are electrically connected in series from an electrical flow path start end 11 (positive electrode) to the electrical flow path terminal end 12 (negative electrode) of the cell laminate 1. The electrical flow path start end 11 and the electrical flow path terminal end 12 are connected, for example, to other cell laminates or a junction box on which various wiring components are mounted via a conductive connection member (for example, a busbar).

Next, the connection of the positive electrode tab leads 21 and the negative electrode tab leads 22 of the plurality of laminated cells 2 will be described with reference to FIGS. 3 to 5.

FIG. 3 shows the connection of the positive electrode tab leads 21 and the negative electrode tab leads 22 of six adjacent laminated cells 2. Although FIG. 3 shows connection in an X portion in FIG. 1 as an example, the connection of the tab leads in a portion other than the X portion is similarly performed. In the following, for convenience of description, among the six adjacent laminated cells 2, the three laminated cells arranged on one end side (a right side in FIG. 3) in a lamination direction are denoted by a reference numeral 2A, and the three laminated cells arranged on the other end side (a left side in FIG. 3) in the lamination direction are denoted by a reference numeral 2B, and the laminated cells 2A and 2B have the same configuration as the laminated cells 2 described above.

Among the six adjacent laminated cells 2, the three laminated cells 2A are connected in parallel with each other, and the three laminated cells 2B are connected in parallel with each other. The three laminated cells 2A connected in parallel and the three laminated cells 2B connected in parallel are electrically connected in series via a conductive connection member 30. Specifically, the positive electrode tab leads 21 of the three laminated cells 2A connected in parallel and the negative electrode tab leads 22 of the three laminated cells 2B connected in parallel are connected to the conductive connection member 30, so that the laminated cells 2A and the laminated cells 2B are electrically connected in series.

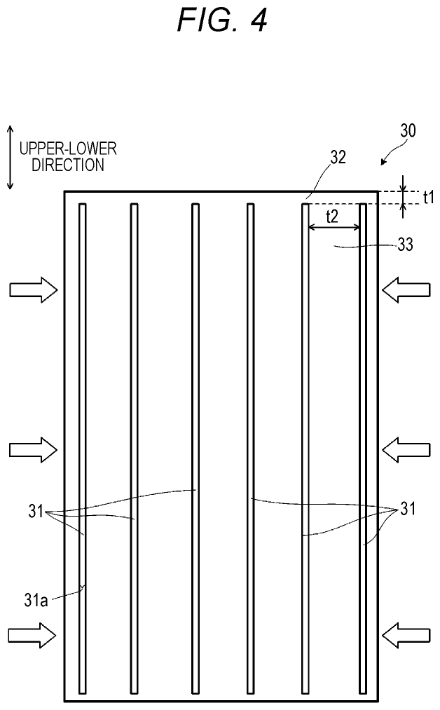

As shown in FIG. 4, the conductive connection member 30 is a plate-shaped member such as a busbar. In the example shown in FIG. 3, the tab leads 21 and 22 of the six laminated cells 2 are connected to one conductive connection member 30.

A plurality of slits 31 are provided in the conductive connection member 30. The number of slits 31 is equal to the number of laminated cells 2 connected to one conductive connection member 30, and is six in the present embodiment. The slits 31 extend in an upper-lower direction, and the tab leads 21 and 22 are inserted into the slits 31 respectively.

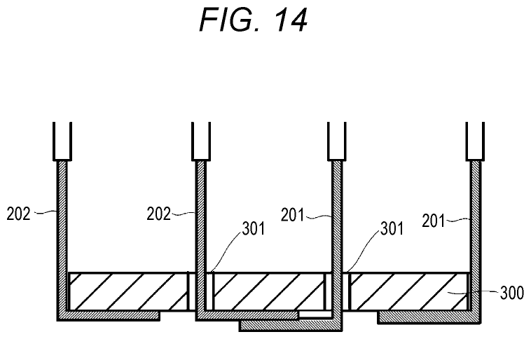

The tab leads 21 and 22 connected to the conductive connection member 30 respectively include linear portions 211 and 221 extending linearly from the sealing portions 20 to tip ends 21a and 22a in a direction perpendicular to the lamination direction. When connecting a conductive connection member provided with a slit to a tab lead, the tab lead is inserted through the slit, and a tip end portion of the tab lead that passes through the slit is sometimes bent (see FIG. 14), but in the present embodiment, the tab leads 21 and 22 are not bent. That is, the tab leads 21 and 22 respectively include the linear portions 211 and 221, and are connected to the conductive connection member 30 at the linear portions 211 and 221.

The tip ends 21a and 22a of the tab leads 21 and 22 are inserted into the respective slits 31. In the example shown in FIG. 3, the tips (parts of the tip ends 21a and 22a which are furthest from the sealing portion 20) of the tab leads 21 and 22 do not protrude outside the slits 31 in an extension direction of the tab leads 21 and 22. That is, the tips of the tab leads 21 and 22 are disposed inside the respective slits 31. However, the tips of the tab leads 21 and 22 may protrude outside the respective slits 31.

After the tip ends 21a and 22a of the tab leads 21 and 22 are inserted into the respective slits 31, when a load is applied to the conductive connection member 30 from both sides in the lamination direction of the laminated cells 2 (see white arrows in FIG. 4), the tip ends 21a and 22a are brought into close contact with the conductive connection member 30 on both surfaces perpendicular to the lamination direction by surfaces 31a which forms the slits 31 and are parallel to the extension direction of the tab leads 21 and 22.

In this way, in the first embodiment, in an inner connection portion 37 located at an inner side of the conductive connection member 30 in the lamination direction among the portions where the tip ends 21a and 22a of the tab leads 21 and 22 and the conductive connection member 30 are electrically connected, the tip ends 21a and 22a are brought into close contact with the conductive connection member 30 by the surfaces 31a, which are parallel to the extension direction of the tab leads 21 and 22, of surfaces of the conductive connection member 30. Similarly, in outer connection portions 38 located at outer sides of the conductive connection member 30 in the lamination direction among the portions where the tip ends 21a and 22a of the tab leads 21 and 22 and the conductive connection member 30 are electrically connected, the tip ends 21a and 22a are brought into close contact with the conductive connection member 30 by the surfaces 31a.

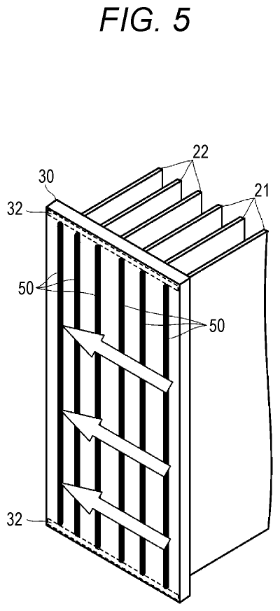

In this state, the tab leads 21 and 22 are bonded to the conductive connection member 30. The tab leads 21 and 22 and the conductive connection member 30 are bonded by a predetermined bonding process such as laser welding or ultrasonic bonding. FIG. 5 shows the conductive connection member 30 after the bonding process is performed along the respective slits 31 into which the tab leads 21 and 22 are inserted. As shown in FIG. 5, bonding portions 50 are formed along the slits 31 on the surface of the conductive connection member 30. After the tab leads 21 and 22 and the conductive connection member 30 are bonded in this manner, the respective slits 31 are filled with the tab leads 21 and 22 and the bonding portions 50. Therefore, the conductive connection member 30 and the tab leads 21 and 22 are stably conducted in the lamination direction without interruption (see white arrows in FIG. 5).

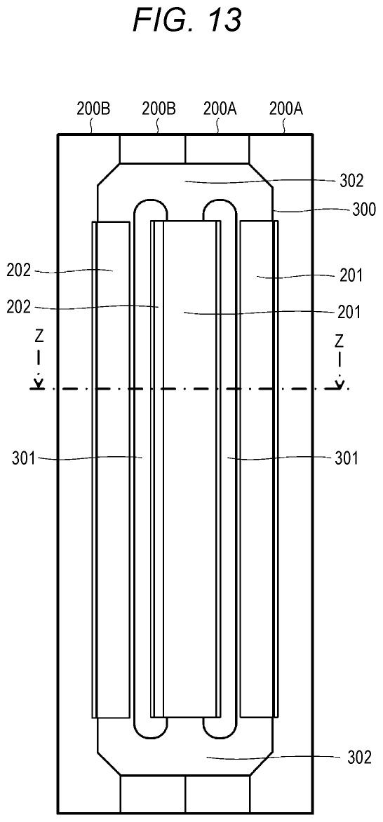

As described above, in the inner connection portion 37 located at the inner side of the conductive connection member 30 in the lamination direction, the tip ends 21a and 22a of the laminated cells 2A and 2B are bonded in close contact with the conductive connection member 30 by the surfaces 31a, which are parallel to the extension direction of the tab leads 21 and 22, of the surfaces of the conductive connection member 30, and thus, the conductive connection member 30 and the tab leads 21 and 22 are conducted in the lamination direction without interruption. Therefore, unlike the configuration shown in FIG. 13, portions of the conductive connection member 30 provided at positions not overlapping the tab leads 21 and 22 when viewed from the lamination direction, that is, ends 32 of the conductive connection member 30 on the outer sides in the longitudinal direction of the respective slits 31 do not need to have a large conductive area. That is, the ends 32 of the conductive connection member 30 can be made small. The conductive connection member 30 and the tab leads 21 and 22 are conducted in the lamination direction without interruption and a sufficient conductive area is ensured, and thus, it is unnecessary to increase a thickness of the conductive connection member 30 in order to secure the conductive area, that is, the conductive connection member 30 can be formed thin. Therefore, it is possible to connect the tab leads 21 and 22 of the plurality of laminated cells 2 and the conductive connection member 30 in a space-saving manner. In this way, a manufacturing cost and weight of the cell laminate 1 can be reduced, and a size can be reduced.

Furthermore, in the present embodiment, the tip ends 21a and 22a, which are part of the linear portions 211 and 221 of the tab leads 21 and 22, are bonded to the conductive connection member 30, and thus, a bending step of the tab leads 21 and 22 becomes unnecessary. Since bent portions of the tab leads 21 and 22 are not provided, a length of the tab leads 21 and 22 can be shortened accordingly, and the manufacturing cost and weight of the plurality of laminated cells 2 can be reduced. Furthermore, since the bending step is unnecessary, productivity of the cell laminate 1 is also improved.

By the way, it is preferable that the ends 32 of the conductive connection member 30 described above have a shape that is easily deformed when a load is applied to the conductive connection member 30 from both sides in the lamination direction. In order to facilitate deformation when a load is applied, for example, as shown in FIG. 4, the conductive connection member 30 is configured such that a length t1 in the longitudinal direction of the ends 32 located on the outer sides in the longitudinal direction of the respective slits 31 is shorter than a length 12 in the lamination direction of a portion 33 located between the adjacent slits 31. Accordingly, the tip ends 21a and 22a of the tab leads 21 and 22 are easily brought into close contact with the surfaces 31a of the slits 31 on both surfaces perpendicular to the lamination direction.

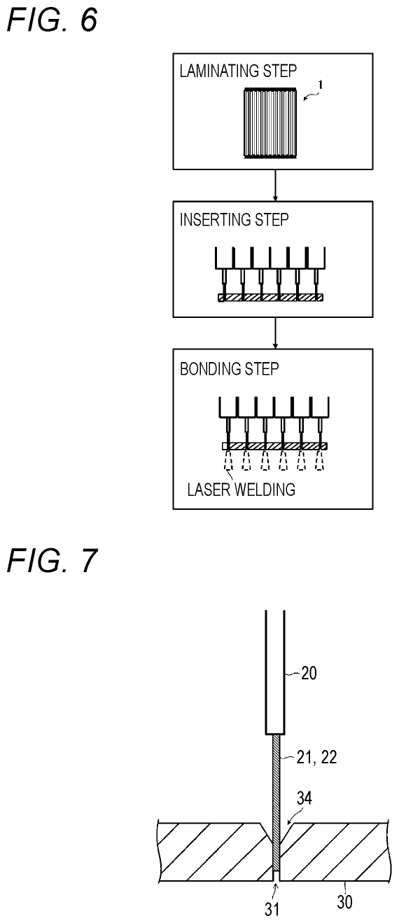

Next, a method for manufacturing the cell laminate 1 according to the first embodiment will be described with reference to FIG. 6.

FIG. 6 is a diagram illustrating the method for manufacturing the cell laminate 1 according to the first embodiment. The method for manufacturing the cell laminate 1 includes a laminating step, an inserting step, and a bonding step. In the laminating step, the plurality of laminated cells 2 are laminated in the horizontal direction. After the laminating step, in the inserting step, the tab leads 21 and 22 of the plurality of laminated cells 2 are inserted into the slits 31 of the conductive connection member 30. After the inserting step, in the bonding step, for example, laser welding is performed along the slits 31 to bond the tab leads 21 and 22 and the conductive connection member 30 while a load is applied to the conductive connection member 30 from both sides in the lamination direction. As described above, the cell laminate 1 is manufactured.

### First Modification

In the conductive connection member 30 according to the first modification, as shown in FIG. 7, an entrance of each slit 31 is chamfered. Specifically, a chamfered portion 34 is formed at the entrance of each slit 31 to guide insertion of the tab leads 21 and 22 from a plate thickness direction of the conductive connection member 30. The chamfered portions 34 facilitate the insertion of the tab leads 21 and 22 into the respective slits 31.

### Second Modification

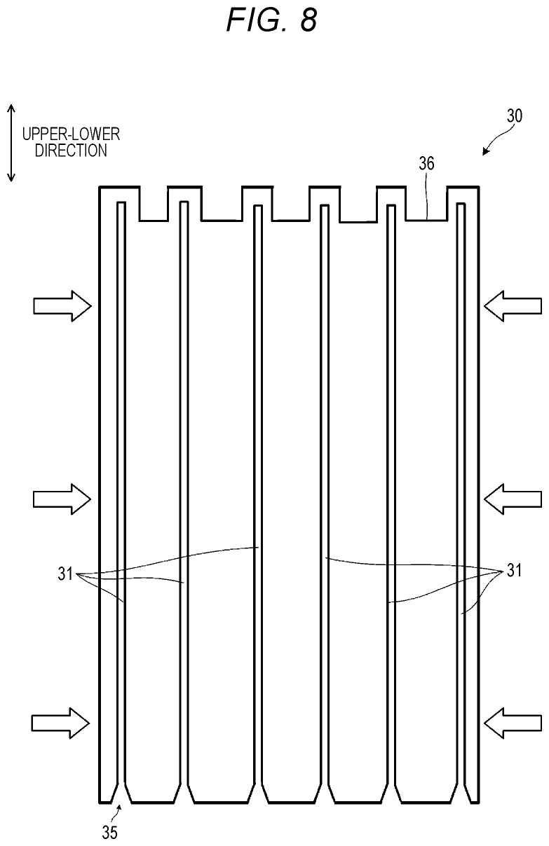

In the conductive connection member 30 according to a second modification, as shown in FIG. 8, one end (here, a lower end) in the longitudinal direction of each slit 31 is open and the other end (here, an upper end) thereof is closed. In other words, the plurality of slits 31 of the conductive connection member 30 are configured in a comb shape. According to such a configuration, for example, in a state in which the plurality of laminated cells 2 are laminated in the horizontal direction, by inserting the conductive connection member 30 into the tab leads 21 and 22 from above, the tab leads 21 and 22 can be easily inserted into the slits 31.

The open lower end in the longitudinal direction of each slit 31 is chamfered. Specifically, a chamfered portion 35 is formed at the lower end of each slit 31 to guide insertion of the conductive connection member 30 into the tab leads 21 and 22 from above. The chamfered portion 35 facilitates the insertion of the tab leads 21 and 22 into the respective slits 31.

In order to easily deform the conductive connection member 30 when a load (white arrows in FIG. 8) is applied to the conductive connection member 30 from both sides in the lamination direction, the conductive connection member 30 according to the second modification is provided with notches 36 between the adjacent slits 31 at the upper end. Accordingly, the tip ends 21a and 22a of the tab leads 21 and 22 are easily brought into close contact with the surfaces 31a of the slits 31 on both surfaces perpendicular to the lamination direction.

### Second Embodiment

Next, the cell laminate 1 according to a second embodiment of the present invention will be described. Since the plurality of laminated cells 2 are common to those according to the first embodiment, the laminated cells are denoted by common reference numerals and descriptions thereof are omitted. A direction where the plurality of laminated cells 2 are laminated is also the same as in the first embodiment, which is the horizontal direction.

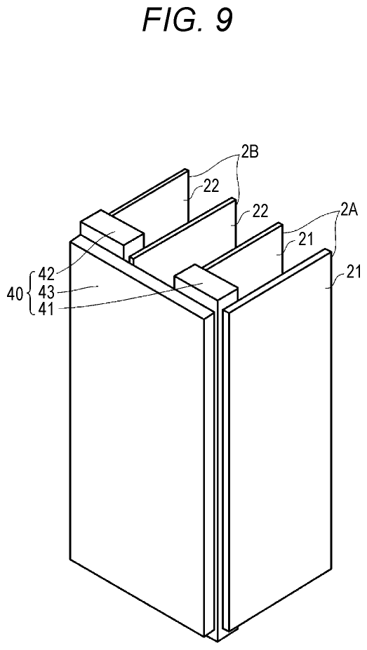

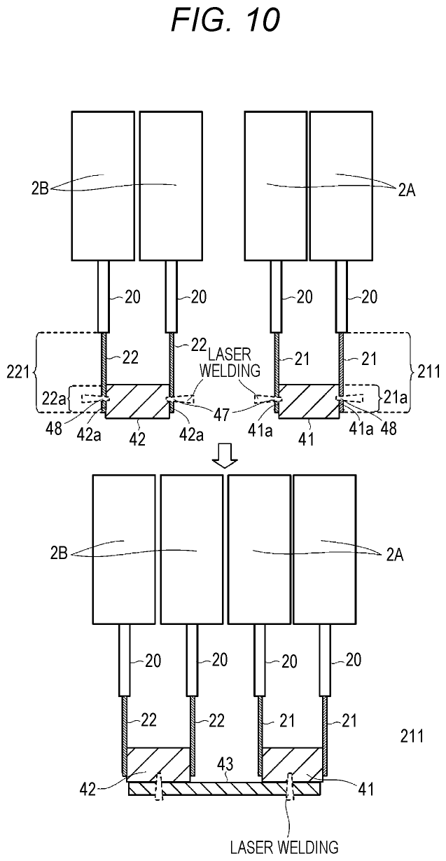

First, a configuration for connecting the positive electrode tab leads 21 and the negative electrode tab leads 22 of the four adjacent laminated cells 2 via a conductive connection member 40 will be described with reference to FIGS. 9 and 10. In the following, for convenience of description, among the four adjacent laminated cells 2, the two laminated cells arranged on one end side (a right side in FIG. 10) in the lamination direction are denoted by the reference numeral 2A, and the two laminated cells arranged on the other end side (a left side in FIG. 10) in the lamination direction are denoted by the reference numeral 2B, and the laminated cells 2A and 2B have the same configuration as the laminated cells 2 described above.

Among the four adjacent laminated cells 2, the two laminated cells 2A are connected in parallel with each other, and the two laminated cells 2B are connected in parallel with each other. The two laminated cells 2A connected in parallel and the two laminated cells 2B connected in parallel are electrically connected in series via the conductive connection member 40. Specifically, the positive electrode tab leads 21 of the two laminated cells 2A connected in parallel and the negative electrode tab leads 22 of the two laminated cells 2B connected in parallel are connected to the conductive connection member 40, so that the laminated cells 2A and the laminated cells 2B are electrically connected in series.

The conductive connection member 40 includes a first conductive connection member 41, a second conductive connection member 42, and a third conductive connection member 43. The first conductive connection member 41, the second conductive connection member 42, and the third conductive connection member 43 are plate-shaped members, such as busbars.

The first conductive connection member 41 connects the positive electrode tab leads 21 of the two adjacent laminated cells 2A. Specifically, the first conductive connection member 41 is disposed between the two adjacent positive electrode tab leads 21, and the tip end 21a of each positive electrode tab lead 21 is bonded in close contact with the first conductive connection member 41 by a surface 41a, which is parallel to the extension direction of the positive electrode tab leads 21, of surfaces of the first conductive connection member 41. Bonding between the positive electrode tab lead 21 and the first conductive connection member 41 is performed by laser welding, ultrasonic bonding, or the like.

The second conductive connection member 42 connects the negative electrode tab leads 22 of the two adjacent laminated cells 2B. Specifically, the second conductive connection member 42 is disposed between the two adjacent negative electrode tab leads 22, and the tip end 22a of each negative electrode tab lead 22 is bonded in close contact with the second conductive connection member 42 by a surface 42a, which is parallel to the extension direction of the negative electrode tab leads 22, of surfaces of the second conductive connection member 42. The bonding between the negative electrode tab leads 22 and the second conductive connection member 42 is performed by laser welding, ultrasonic bonding, or the like.

In this way, also in the second embodiment, in inner connection portions 47 located at an inner side of the conductive connection member 40 in the lamination direction among the portions where the tip ends 21a and 22a of the tab leads 21 and 22 and the conductive connection member 40 are electrically connected, the tip ends 21a and 22a are bonded in close contact with the conductive connection member 40 by the surfaces 41a and 42a, which are parallel to the extension direction of the tab leads 21 and 22, of the surfaces of the conductive connection member 40. Similarly, in outer connection portions 48 located at outer sides of the conductive connection member 40 in the lamination direction among the portions where the tip ends 21a and 22a of the tab leads 21 and 22 and the conductive connection member 40 are electrically connected, the tip ends 21a and 22a are bonded in close contact with the conductive connection member 40 by the surfaces 41a and 42a.

The third conductive connection member 43 electrically connects the first conductive connection member 41 to which the positive electrode tab lead 21 is bonded and the second conductive connection member 42 to which the negative electrode tab lead 22 is bonded. The third conductive connection member 43 is disposed outside the first conductive connection member 41 and the second conductive connection member 42 in the extension direction of the tab leads 21 and 22, and is bonded to overlap the first conductive connection member 41 and the second conductive connection member 42. The bonding between the third conductive connection member 43, the first conductive connection member 41, and the second conductive connection member 42 is performed by laser welding, ultrasonic bonding, or the like.

As described above, the first conductive connection member 41 to which the positive electrode tab lead 21 is connected and the second conductive connection member 42 to which the negative electrode tab lead 22 is connected are electrically connected via the third conductive connection member 43. According to such a configuration, unlike the first embodiment and the configuration in FIG. 13, the tab leads 21 and 22 and the conductive connection member 40 can be bonded without forming a slit in the conductive connection member 40. Therefore, it is unnecessary to provide conductive connection members in an upper region and a lower region of the tab leads 21 and 22, such as both ends 302 of the configuration in FIG. 13. Since the conductive connection member 40 is not provided with a slit, the third conductive connection member 43 can be formed thinner than a conductive connection member provided with a slit.

In the present embodiment, the first conductive connection member 41, the second conductive connection member 42, and the third conductive connection member 43 are preferably made of the same kind of metal material. Accordingly, bonding between the first conductive connection member 41 and the third conductive connection member 43 and the bonding between the second conductive connection member 42 and the third conductive connection member 43 are facilitated.

Here, the first conductive connection member 41, the second conductive connection member 42, and the third conductive connection member 43 are preferably made of aluminum, for example. Since aluminum is an inexpensive and lightweight material, the manufacturing cost and weight of the cell laminate 1 can be reduced.

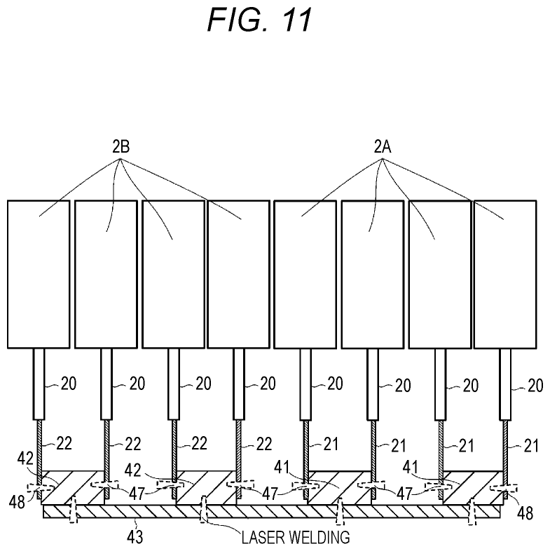

When the positive electrode tab leads 21 of L (L represents an even number of 4 or more) laminated cells 2 connected in parallel and the negative electrode tab leads 22 of the L laminated cells 2 connected in parallel are electrically connected in series via the conductive connection member 40, the number of the first conductive connection members 41 and the number of the second conductive connection members 42 may be L/2 respectively. FIG. 11 shows an example of a case where the positive electrode tab leads 21 of the four laminated cells 2 connected in parallel and the negative electrode tab leads 22 of the four laminated cells 2 connected in parallel are electrically connected in series via the conductive connection member 40. In this case, two first conductive connection members 41 are provided and two second conductive connection members 42 are provided. The third conductive connection member 43 is electrically connected to the two first conductive connection members 41 and the two second conductive connection members 42.

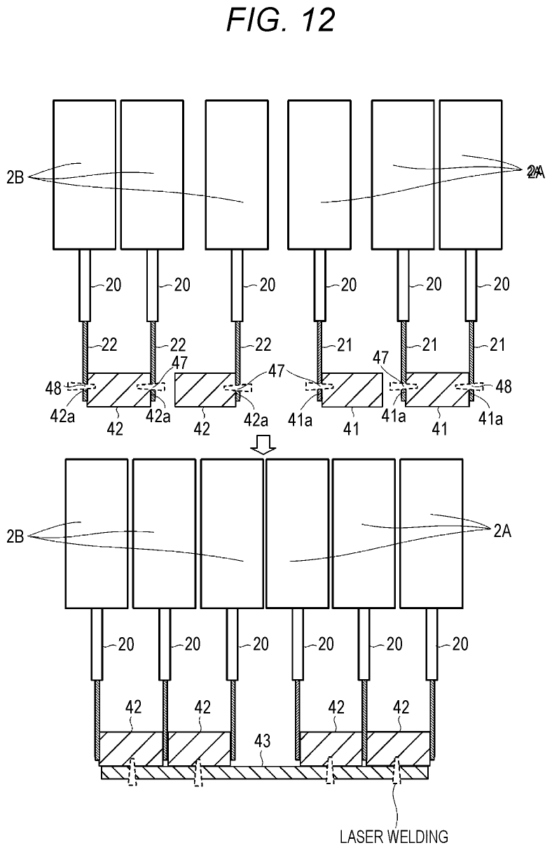

Next, a configuration for connecting the positive electrode tab leads 21 and the negative electrode tab leads 22 of the six adjacent laminated cells 2 via the conductive connection member 40 will be described with reference to FIG. 12. In the following, for convenience of description, among the six adjacent laminated cells 2, the three laminated cells arranged on one end side (a right side in FIG. 12) in the lamination direction are denoted by the reference numeral 2A, and the three laminated cells arranged on the other end side (a left side in FIG. 12) in the lamination direction are denoted by the reference numeral 2B, and the laminated cells 2A and 2B have the same configuration as the laminated cells 2 described above.

Among the six adjacent laminated cells 2, the three laminated cells 2A are connected in parallel with each other, and the three laminated cells 2B are connected in parallel with each other. The three laminated cells 2A connected in parallel and the three laminated cells 2B connected in parallel are electrically connected in series via the conductive connection member 40.

The conductive connection member 40 includes the two first conductive connection members 41, the two second conductive connection member 42, and the one third conductive connection member 43.

One of the two first conductive connection members 41 connects the positive electrode tab leads 21 of the two adjacent laminated cells 2A. The other of the two first conductive connection members 41 is connected to the positive electrode tab lead 21 of the one left laminated cell 2A at only one position. Since the bonding is the same as the configuration shown in FIGS. 9 and 10, a description thereof is omitted.

One of the two second conductive connection members 42 connects the negative electrode tab leads 22 of the two adjacent laminated cells 2B. The other of the two second conductive connection members 42 is connected to the negative electrode tab lead 22 of the one left laminated cell 2B at only one position.

That is, also in this case, in the inner connection portions 47 located at the inner side of the conductive connection member 40 in the lamination direction among the portions where the tip ends 21a and 22a of the tab leads 21 and 22 and the conductive connection member 40 are electrically connected, the tip ends 21a and 22a are bonded in close contact with the conductive connection member 40 by the surfaces 41a and 42a, which are parallel to the extension direction of the tab leads 21 and 22, of the surfaces of the conductive connection member 40. Similarly, in outer connection portions 48 located at outer sides of the conductive connection member 40 in the lamination direction among the portions where the tip ends 21a and 22a of the tab leads 21 and 22 and the conductive connection member 40 are electrically connected, the tip ends 21a and 22a are bonded in close contact with the conductive connection member 40 by the surfaces 41a and 42a.

The third conductive connection member 43 electrically connects the two first conductive connection members 41 to which the positive electrode tab leads 21 are bonded and the two second conductive connection member 42 to which the negative electrode tab leads 22 are bonded. According to such a configuration, the positive electrode tab leads 21 and the negative electrode tab leads 22 of the six adjacent laminated cells 2 can be connected via the conductive connection member 40.

When the positive electrode tab leads 21 of M (M represents an odd number of 5 or more) laminated cells 2 connected in parallel and the negative electrode tab leads 22 of the M laminated cells 2 connected in parallel are electrically connected in series via the conductive connection member 40, the number of the first conductive connection members 41 and the number of the second conductive connection members 42 may be (M+1)/2 respectively.

Although the embodiments of the present invention have been described above with reference to the accompanying drawings, it is needless to say that the present invention is not limited to the embodiments. It is apparent that those skilled in the art can conceive of various modifications and changes within the scope described in the claims, and it is understood that such modifications and changes naturally fall within the technical scope of the present invention. In addition, respective constituent elements in the above embodiments may be freely combined without departing from the gist of the invention.

In the present specification, at least the following matters are described. In parentheses, corresponding components and the like in the above embodiments are shown as an example, but the present invention is not limited thereto.

(1) A cell laminate (cell laminate 1), including:
a plurality of laminated cells (a plurality of laminated cells 2) which are laminated, in which
each laminated cell includes a sealing portion (sealing portion 20) on a peripheral edge, and is configured such that a tab lead (tab leads 21 and 22) extends from the sealing portion in a direction perpendicular to a lamination direction,
the tab leads of at least four laminated cells among the plurality of laminated cells are electrically connected to each other via a conductive connection member (conductive connection member 30, conductive connection member 40) having a plate shape,
each tab lead connected to the conductive connection member has a linear portion (linear portions 211 and 221) extending linearly in the direction perpendicular to the lamination direction from the sealing portion to a tip end (tip ends 21a and 22a), and
in a connection portion (inner connection portion 37, inner connection portions 47) located at an inner side of the conductive connection member in the lamination direction among portions where the tip ends of the tab leads and the conductive connection member are electrically connected, the tip ends are bonded in close contact with the conductive connection member by a surface (surfaces 31a, surfaces 41a and 42a), which is parallel to an extension direction of the tab leads, of surfaces of the conductive connection member.

According to (1), in the inner connection portion located at the inner side of the conductive connection member in the lamination direction, the tip ends of the plurality of laminated cells are bonded in close contact with the conductive connection by the surface, which is parallel to the extension direction of the tab leads, of the surfaces of the conductive connection member, and thus, the conductive connection member and the tab leads are conducted in the lamination direction without interruption. Therefore, it is possible to reduce or eliminate a conductive area of a portion, which is provided at a position not overlapping the tab leads, of the conductive connection member when viewed in the lamination direction. The conductive connection member and the tab leads are conducted in the lamination direction without interruption and a sufficient conductive area is ensured, and thus, it is unnecessary to increase a thickness of the conductive connection member in order to secure the conductive area. Therefore, it is possible to save a space for a connection portion of the tab leads of the plurality of laminated cells.

(2) The cell laminate according to (1), in which
the conductive connection member is provided with a plurality of slits (slits 31),
the tip ends of the tab leads are inserted into the respective slits, and
the tip ends of the tab leads are bonded in close contact with the conductive connection member on both surfaces perpendicular to the lamination direction by surfaces which constitute the slits and are parallel to the extension direction of the tab leads.

According to (2), the tip ends of the tab leads are inserted into the respective slits and are bonded in close contact with the conductive connection member, and thus, the conductive connection member and the tab leads are stably electrically conducted in the lamination direction.

(3) The cell laminate according to (2), in which
the conductive connection member is configured such that a length in a longitudinal direction of each of portions located on outer sides in the longitudinal direction of the slits is shorter than a length in the lamination direction of a portion located between the adjacent slits.

According to (3), since the conductive connection member is easily deformed when a load is applied from both sides in the lamination direction, the conductive connection member and the tab lead can be easily brought into close contact with each other at each slit.

(4) The cell laminate according to (2) or (3), in which
an entrance of each slit is chamfered.

According to (4), the tab lead can be easily inserted into the slit.

(5) The cell laminate according to any one of (2) to (4), in which
one end in a longitudinal direction of each slit is open and the other end of the slit is closed.

According to (5), the tab lead can be easily inserted into the slit.

(6) The cell laminate according to (1), in which
the conductive connection member includes a first conductive connection member (first conductive connection member 41), a second conductive connection member (second conductive connection member 42), and a third conductive connection member (third conductive connection member 43),
the plurality of laminated cells includes a plurality of first laminated cells that are adjacent in the lamination direction and electrically connected in parallel, and a plurality of second laminated cells that are adjacent in the lamination direction and are electrically connected in parallel,
the tip ends of the tab leads of the plurality of first laminated cells are bonded in close contact with the first conductive connection member by a surface (surface 41a), which is parallel to the extension direction of the tab leads, of surfaces of the first conductive connection member,
the tip ends of the tab leads of the plurality of second laminated cells are bonded in close contact with the second conductive connection member by a surface (surface 42a), which is parallel to the extension direction of the tab leads, of surfaces of the second conductive connection member, and
the first conductive connection member and the second conductive connection member are electrically connected to each other via the third conductive connection member.

According to (6), since the tab lead and the conductive connection member can be bonded without providing a slit in the conductive connection member, the third conductive connection member can be formed thinner than the conductive connection member provided with the slit.

(7) The cell laminate according to (6), in which
the first conductive connection member, the second conductive connection member, and the third conductive connection member are made of the same kind of metal material.

According to (7), the same kind of metal material facilitates bonding between the first conductive connection member and the third conductive connection member and bonding between the second conductive connection member and the third conductive connection member.

(8) The cell laminate according to (7), in which
the first conductive connection member, the second conductive connection member, and the third conductive connection member are made of aluminum.

According to (8), since aluminum is an inexpensive and lightweight material, a manufacturing cost and weight of the cell laminate can be reduced.

What is claimed is:

1. A cell laminate, comprising:
a plurality of laminated cells which are laminated, wherein
each laminated cell includes a sealing portion on a peripheral edge, and is configured such that a tab lead extends from the sealing portion in a direction perpendicular to a lamination direction,
the tab leads of at least four laminated cells among the plurality of laminated cells are electrically connected to each other via a conductive connection member having a plate shape,
each tab lead connected to the conductive connection member has a linear portion extending linearly in the direction perpendicular to the lamination direction from the sealing portion to a tip end, and
in a connection portion located at an inner side of the conductive connection member in the lamination direction among portions where the tip ends of the tab leads and the conductive connection member are electrically connected, the tip ends are bonded in close contact with the conductive connection member by a surface, which is parallel to an extension direction of the tab leads, of surfaces of the conductive connection member.

2. The cell laminate according to claim 1, wherein
the conductive connection member is provided with a plurality of slits,
the tip ends of the tab leads are inserted into the respective slits, and
the tip ends of the tab leads are bonded in close contact with the conductive connection member on both surfaces perpendicular to the lamination direction by surfaces which constitute the slits and are parallel to the extension direction of the tab leads.

3. The cell laminate according to claim 2, wherein
the conductive connection member is configured such that a length in a longitudinal direction of each of portions located on outer sides in the longitudinal direction of the slits is shorter than a length in the lamination direction of a portion located between the adjacent slits.

4. The cell laminate according to claim 2, wherein
an entrance of each slit is chamfered.

5. The cell laminate according to claim 2, wherein
one end in a longitudinal direction of each slit is open and the other end of the slit is closed.

6. The cell laminate according to claim 1, wherein
the conductive connection member includes a first conductive connection member, a second conductive connection member, and a third conductive connection member,
the plurality of laminated cells includes a plurality of first laminated cells that are adjacent in the lamination direction and electrically connected in parallel, and a plurality of second laminated cells that are adjacent in the lamination direction and are electrically connected in parallel,
the tip ends of the tab leads of the plurality of first laminated cells are bonded in close contact with the first conductive connection member by a surface, which is parallel to the extension direction of the tab leads, of surfaces of the first conductive connection member,
the tip ends of the tab leads of the plurality of second laminated cells are bonded in close contact with the second conductive connection member by a surface, which is parallel to the extension direction of the tab leads, of surfaces of the second conductive connection member, and
the first conductive connection member and the second conductive connection member are electrically connected to each other via the third conductive connection member.

7. The cell laminate according to claim 6, wherein
the first conductive connection member, the second conductive connection member, and the third conductive connection member are made of the same kind of metal material.

8. The cell laminate according to claim 7, wherein
the first conductive connection member, the second conductive connection member, and the third conductive connection member are made of aluminum.
